(19) United States
(12) Patent Application Publication
(10) Pub. No.: US 2011/0161103 A1
(43) Pub. Date: Jun. 30, 2011

(54) SYSTEMS AND METHODS FOR ELECTRONIC MEDICAL SUPPORT

(75) Inventors: Nathan Alan Dye, Seattle, WA (US); Gregory Mark Meyer, Tacoma, WA (US); Elidoforos Soterakis Soteriades, Nicosia (CY); George Andreas Samoutis, Nicosia (CY); Kirk Thomas Harmon, Tacoma, WA (US)

(73) Assignee: EHIPPOCRATES LLC, Tacoma, WA (US)

(21) Appl. No.: 12/979,615

(22) Filed: Dec. 28, 2010

Related U.S. Application Data
(60) Provisional application No. 61/290,432, filed on Dec. 28, 2009.

(51) Int. Cl. G06Q 50/00

(52) U.S. Cl. 705/2

(57) ABSTRACT

Disclosed herein are various embodiments of systems and methods for providing electronic medical support that utilize an electronic examination template. According to various embodiments, the electronic examination template may include an examination step relating to a medical complaint, a clinical clue associated with the examination step to inform a user on how to proceed with the examination step, and an information field to allow a user to input information related to the examination step.

### RELATED APPLICATIONS

This application claims priority under 35 U.S.C. §119(e) to U.S. Provisional Patent Application No. 61/290,432, filed Dec. 28, 2009, and entitled “SYSTEMS AND METHODS FOR ELECTRONIC MEDICAL SUPPORT,” which is hereby incorporated by reference in its entirety.

### TECHNICAL FIELD

This disclosure generally relates to systems and methods for providing electronic medical support. More particularly, an electronic medical support system requests information regarding a patient and generates a medical impression, probability of correct diagnosis, and/or a treatment plan.

### BRIEF DESCRIPTION OF THE DRAWINGS

Non-limiting and non-exhaustive embodiments of the disclosure are described, including various embodiments of the disclosure with reference to the figures, in which:

FIG. 1 illustrates an organizational hierarchy of an electronic medical support system, according to one exemplary embodiment.

FIG. 2 illustrates an exemplary flowchart of a method for performing a patient examination.

FIG. 3 illustrates a functional block diagram of a system for providing electronic medical support, according to one exemplary embodiment.

FIG. 4 illustrates a functional block diagram of a server-client system for providing electronic medical support, according to one exemplary embodiment.

FIG. 5 illustrates an exemplary home screen including a search function, navigation links, and navigation tabs.

FIG. 6 illustrates a screen allowing for the selection of one or more examination templates, according to one exemplary embodiment.

FIG. 7 illustrates an exemplary first portion of a merged examination template.

FIG. 8 illustrates additional examination steps of the merged examination template, according to one exemplary embodiment.

FIG. 9 illustrates a screen showing a clinical clue associated with an examination step of an examination template, according to one exemplary embodiment.

FIG. 10 illustrates additional examination steps in the form of diagnostic tests, according to one exemplary embodiment.

FIG. 11 illustrates a screen showing a medical impression and an associated treatment plan, according to one exemplary embodiment.

FIG. 12 illustrates a screen showing an exemplary examination summary including a summary of relevant patient information, a medical impression, and a treatment plan.

In the following description, numerous specific details are provided for a thorough understanding of the various embodiments disclosed herein. The systems and methods disclosed herein can be practiced without one or more of the specific details, or with other methods, components, materials, etc. In addition, in some cases, well-known structures, materials, or operations may not be shown or described in detail in order to avoid obscuring aspects of the disclosure. Furthermore, the described features, structures, or characteristics may be combined in any suitable manner in one or more alternative embodiments.

### DETAILED DESCRIPTION

The present disclosure provides systems and methods for medical practitioners to systematically generate medical impressions and potential treatment plans. According to various embodiments, the electronic medical support system allows practitioners to take advantage of the vast amount of medical information available electronically. According to the variously described embodiments, the system is specifically adapted to meet the unique needs of the medical practice. Accordingly, the present systems and methods avoid cumbersome processes that would otherwise unduly constrain medical practitioners.

In addition to basic charting operations and historical record collecting, an electronic medical support system may be configured to guide a practitioner from an initial patient complaint to a medical impression and/or potential treatment plans. Accordingly, various embodiments of the present system and method separate pertinent medical information from non-pertinent information and present it to a practitioner in a systematic manner.

According to various embodiments, an electronic medical support system may improve patient care, provide organized recordkeeping, improve billing efficiency, allow for more accurate and/or faster diagnoses, and facilitate in the creation of electronic medical records.

According to various embodiments, an electronic medical support system is configured to display information to a practitioner, receive input from the practitioner, and analyze the information provided by the practitioner in order to determine a medical impression and/or treatment plan. According to various embodiments, the electronic medical support system may be embodied in a software program accessed locally, via an intranet, and/or on the Internet.

According to some embodiments, a practitioner is presented with the option of selecting one or more examination templates relating to the chief complaint of a patient. Each of the examination templates may include a number of examination steps intended to guide a practitioner. Alternatively, a practitioner may input the chief complaint(s) and the electronic medical support system may automatically select one or more corresponding examination template. According to various embodiments, if multiple examination templates are selected, the electronic medical support system may merge the selected templates in order to eliminate redundant examination steps.

The electronic medical support system may then request and/or retrieve relevant medical history and present examination steps to be performed by the practitioner. Based on the input received from the practitioner regarding the various examination steps, additional examination steps may be provided, diagnostic steps may be provided, and/or the examination may conclude. After completing the relevant examination steps and/or diagnostic steps the electronic medical support system may analyze the inputs received, potentially in light of the medical history of the patient, and determine a medical impression and/or treatment plan.

According to various embodiments, an examination template may include any number of examination steps. The examination steps may range from simple questions to a request that a practitioner perform a specific examination and input information regarding the results of the examination. According to various embodiments, an answer to an examination step may result in additional related or dependent examination steps.

According to various embodiments, a clinic clue may be associated with an examination step. Clinical clues may provide insights, instructions, definitions, or guidance relating to a specific examination step. For instance, a clinic clue may present a short video guiding a practitioner on how to perform a specific examination or provide example pictures or photographs of what is meant by an examination step. Clinic clues may take the form of text, audio, video, photographs, drawings, and/or combinations thereof.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. In particular, an “embodiment” may be a system, an article of manufacture (such as a computer-readable storage medium), a method, and a product of a process.

The term “medical impression”, “impression”, and variations thereof as used herein should be understood as commonly used in the medical fields. By way of example, a medical impression may comprise a medical examiner's diagnosis, assessment, first impression, and/or immediate impression of a medical problem, disease, issue, or other condition. As used herein a medical impression may be substantially equivalent to a medical diagnosis. Alternatively, a medical impression may be akin to an informed guess, while a medical diagnosis may be a conclusion or intermediate conclusion based on a medical practitioner's weighing of the signs, evaluations, symptoms, and/or test results.

The term “practitioner” as used herein may encompass any user of an electronic medical support system. Specifically, the term practitioner may include, but is not limited to, assistants, doctors, medical professionals, nurses, medical staff, secretaries, physician assistants, nurse practitioners, and the like. According to various embodiments, an electronic medical support system may be adapted for use by practitioners having a specific level of medical training. For example, a system may be adapted for use by medical professionals with a relatively high level of training, or alternatively for use by laypersons having little or no training. Accordingly, the term practitioner may encompass those having sufficient skill to perform the examination steps presented by a particular adaptation of an electronic medical support system.

The phrases “connected to” and “in communication with” refer to any form of interaction between two or more components, including mechanical, electrical, magnetic, and electromagnetic interaction. Two components may be connected to each other even though they are not in direct contact with each other and even though there may be intermediary devices between the two components.

Some of the infrastructure that can be used with embodiments disclosed herein is already available, such as: general-purpose computers, computer programming tools and techniques, digital storage media, and communications networks. A computer may include a processor such as a microprocessor, microcontroller, logic circuitry, or the like. The processor may include a special purpose processing device such as an ASIC, PAL, PLA, PLD, Field Programmable Gate Array, or other customized or programmable device. The computer may also include a computer-readable storage device such as non-volatile memory, static RAM, dynamic RAM, ROM, CD-ROM, disk, tape, magnetic, optical, flash memory, or other computer-readable storage medium.

Suitable networks for configuration and/or use as described herein include one or more local area networks, wide area networks, metropolitan area networks, and/or “Internet” or internet protocol (IP) networks, such as the World Wide Web, a private Internet, a secure Internet, a value-added network, a virtual private network, an extranet, an intranet, or even standalone machines which communicate with other machines by physical transport of media. In particular, a suitable network may be formed from parts or entireties of two or more other networks, including networks using disparate hardware and network communication technologies. A network may incorporate landlines, wireless communication, and combinations thereof.

The network may include communications or networking software, such as software available from Novell, Microsoft, Artisoft, and other vendors, and may operate using TCP/IP, SPX, IPX, and other protocols over twisted pair, coaxial, or optical fiber cables, telephone lines, satellites, microwave relays, modulated AC power lines, physical media transfer, and/or other data transmission “wires” known to those of skill in the art. The network may encompass smaller networks and/or be connectable to other networks through a gateway or similar mechanism.

Various input devices and/or output devices may be utilized in conjunction with the presently describe electronic medical support system. Exemplary input devices include, but are not limited to, a keyboard, mouse, touch screen, light pen, tablet, microphone, sensor, or other hardware with accompanying firmware and/or software. Exemplary output devices include, but are not limited to, a monitor or other display, printer, switch, signal line, or other hardware with accompanying firmware and/or software.

The embodiments of the disclosure will be best understood by reference to the drawings, wherein like parts are designated by like numerals throughout. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified.

Aspects of certain embodiments described herein may be implemented as software modules or components. As used herein, a software module or component may include any type of computer instruction or computer executable code located within or on a computer-readable storage medium. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a computer-readable storage medium, which together implement the described functionality of the module. Indeed, a module may comprise a single instruction or many instructions, and may be distributed over several different code segments, among different programs, and across several computer-readable storage media. Some embodiments may be practiced in a distributed computing environment where tasks are performed by a remote processing device linked through a communications network. In a distributed computing environment, software modules may be located in local and/or remote computer-readable storage media. In addition, data being tied or rendered together in a database record may be resident in the same computer-readable storage medium, or across several computer-readable storage media, and may be linked together in fields of a record in a database across a network.

The software modules described herein tangibly embody a program, functions, and/or instructions that are executable by computer(s) to perform tasks as described herein. Suitable software, as applicable, may be provided using the teachings presented herein and programming languages and tools, such as XML, Java, Pascal, C++, C, database languages, APIs, SDKs, assembly, firmware, microcode, and/or other languages and tools. Additionally, software, firmware, and hardware may be interchangeably used to implement a given function.

In some cases, well-known features, structures or operations are not shown or described in detail. Furthermore, the described features, structures, or operations may be combined in any suitable manner in one or more embodiments. It will also be readily understood that the components of the embodiments as generally described and illustrated in the figures herein could be arranged and designed in a wide variety of different configurations.

In the following description, numerous details are provided to give a thorough understanding of various embodiments; however, the embodiments disclosed herein can be practiced without one or more of the specific details, or with other methods, components, materials, etc. In other instances, well-known structures, materials, or operations are not shown or described in detail to avoid obscuring aspects of this disclosure.

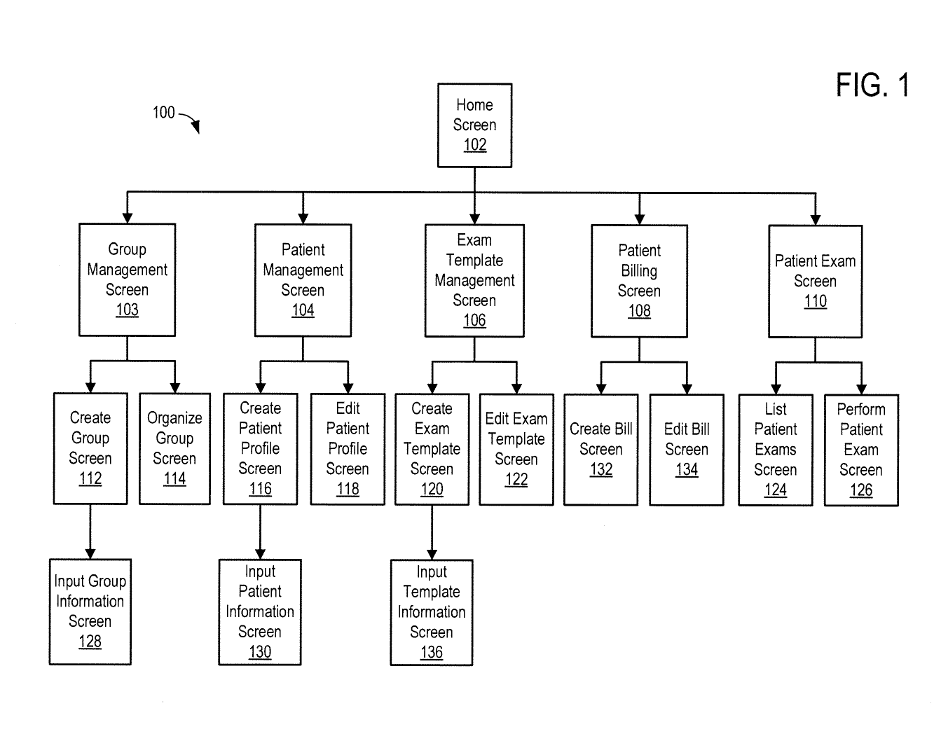

FIG. 1 illustrates the organization of an electronic medical support system 100 according to one exemplary embodiment. According to the illustrated embodiment, system 100 may comprise a hierarchical organization of various screens. According to various embodiments, each screen may provide a user interface to a particular module of system 100. That is, each “screen” of FIG. 1 may represent the user interface to an underlying module, such as a software module, configured to perform specific functions within system 100.

As illustrated, system 100 may include a home screen 102, which may present various navigation options within system 100. For example, home screen 102 may allow navigation to various screens such as group management 103, patient management 104, examination template management 106, patient billing 108, patient examinations 110, and/or additional management screens. From home screen 102, the practitioner may select an option to perform a particular task or perform a search within one or more modules within system 100.

Using group management screen 103, a practitioner may create or view lists of various groups entered into system 100. Groups may be based on one or more shared characteristics. For example, a group may be created based on the billing requirements of a health insurance provider. A particular health insurance provider may have specific requirements such as billing, reporting, claims, forms, and/or the like that may be implemented by system 100 in an automated manner. According to various embodiments, groups may be automatically generated or manually created based on shared characteristics. Additionally, patients, conditions, insurance providers, and/or other managed elements of the system may be included in more than one group.

Groups may provide simplicity in management, form completion, search functionalities, and/or reminders. For example, according to various embodiments, system 100 may remind patients having a common condition to schedule treatments to manage the condition. Groups may be organized based on a wide range of criteria. Certain groups may be automatically populated, while other groups may be manually populated. Patients may be members of a plurality of groups.

Within group management screen 103 groups may be created, at 112, or organized, at 114. Group information may be input within input group information screen 128. Such information may include billing requirements, contact information, EMR format, and the like.

Organize groups screen 114 may allow a practitioner to manually assign patients to a group based on a specified set of criteria. Groups may be organized for temporary purposes or may be permanently assigned for continual management. For example, an automatically populated group may be created to include those patients who may meet a specified condition, such as a required vaccination. Once those patients are treated, the temporary group may be dissolved.

Within patient management screen 104, patient information may be input, at 130, within create patient profile screen 116. Additionally, edit patient profile screen 118 may allow a patient profile to be updated, edited, and/or augmented. According to various embodiments, input patient information screen 130 may allow for a wide variety of information to be entered, including the patient's contact information, medical history, billing information, medications, allergies, medical history, family history, and the like.

Examination template management screen 106 may allow a practitioner to create and examination template, at 120, or edit an existing examination template, at 122. In one embodiment, the examination templates are organized according to the chief complaint given by a patient. For example, a chief complaint may come in the form of a localized pain or difficulty breathing, walking, supporting weight, or sleeping.

According to various embodiments, as described in greater detail below, system 100 may be configured to prompt a practitioner to perform a specific task or examination and provide relevant feedback. In this way, the examination templates may serve to standardize both the procedure of performing a patient examination and the process of creating an electronic medical record. Input template information screen 136 may be used to create a new examination template.

Within patient billing screen 108, a practitioner may proceed to a create bill screen 132 or to edit bill screen 134. In creating a bill, system 100 may utilize information relating to the groups to which the patient belongs. For example, bills for all patients insured by a particular insurance company may be generated in compliance with the insurance company's requirements. As another example, reporting to government agencies and statistical gathering organizations may be performed automatically and/or anonymously. Using edit bill screen 134, one or more bills may be manually edited, updated, and/or augmented.

According to various embodiments, patient billing screen 108, and its sub-screens, may provide user interfaces to various underlying billing modules relying on additional information and/or databases not within system 100. According to some embodiments, patient billing screen 108 provides a user interface to a separate, possibly pre-existing, billing system utilized by the user or users of system 100.

Patient examination screen 110 may allow a medical practitioner to access a list of patient examinations, at 124, or to perform a patient examination, at 126. According to various embodiments, the results of previously completed examinations may be reviewed and/or accessed via patient examination screen 110. According to various embodiments, Group management 103, patient management 104, examination template management 106, and patient billing 108 provide necessary support and initialization for patient examination 110. Patient examination 110 may utilize information throughout system 100 in order to aid a practitioner in systematically developing a medical impression and/or a treatment plan.

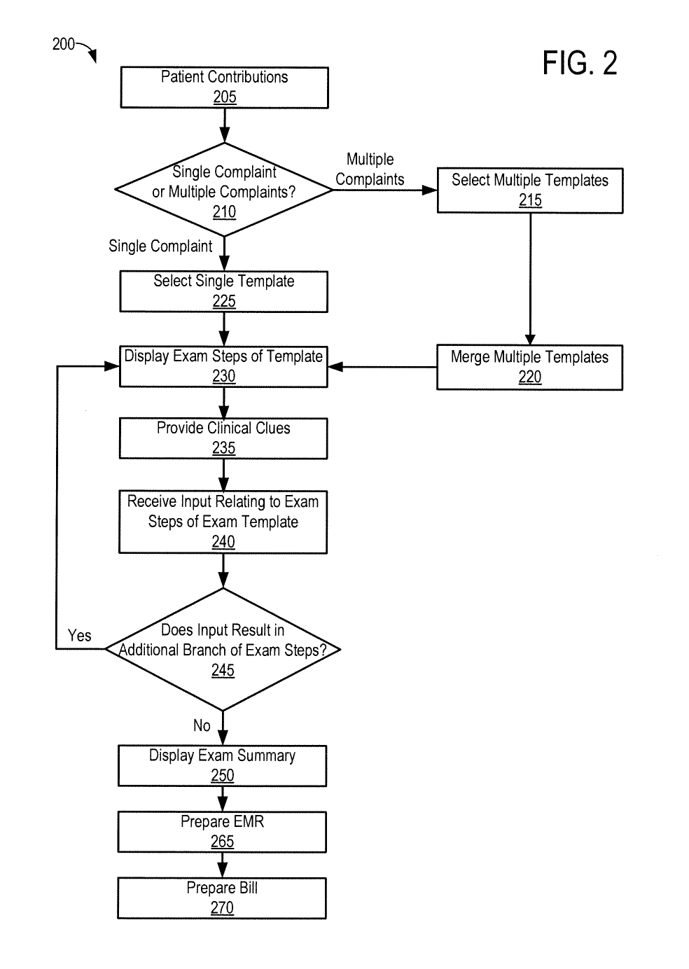

FIG. 2 illustrates a flowchart of one embodiment of a method 200 for performing a patient exam. In certain embodiments, method 200 may begin by gathering information from one or more databases, including those within a system as described in FIG. 1. For example, at 205, a patient may provide his or her patient history, personal information, contact information, and the like. Such patient contributions 205 may be merged into an examination template (referred to as a standard base template). Patient contributions may be input by medical staff and/or by the patient, saving the practitioner time.

At 210, the practitioner may identify one or more chief complaints of the patient. If multiple complaints are identified, multiple examination templates may be selected, at 215. For each complaint, at least one examination template may be selected. According to various embodiments, multiple templates are merged, at 220, so as to omit redundant questions and/or examination steps. For example, a patient may present complaints that his wrist hurts and his fingers hurt. The examination template for “wrist hurts” and the examination template for “fingers hurt” may both contain a question such as “Is patient able to grasp objects?” Accordingly, system 100 may merge the two templates so that “Is patient able to grasp objects?” is only asked once, at 220. Alternatively, a patient may have only a single complaint, at 225. In either case, examination steps of an examination template are presented to the practitioner, at 230.

The selected examination template(s) may be populated with a variety of data types. For example, the patient's historical information and the patient's contributions, from 205, may be used to populate the examination template. According to various embodiments, the displayed examination steps may be presented in a hierarchical order. Continuing the example above, if the practitioner inputs “yes, the patient is able to grasp objects”, the examination template may automatically repopulate and display a series of lower order follow up questions based on the affirmative answer received. Whereas if the practitioner had answered “no”, the system may have displayed a different branch of lower order examination steps based on the negative answer.

System 200 may provide clinical clues associated with an examination step, at 235. The clinical clues may include contextually relevant medical information for the practitioner based on the selected examination template(s). For example, a clinical clue may include text, images, audio, and/or videos. A clinical clue may assist the practitioner in various manners, including guidance in decision-making, training to perform a particular examination, and/or examples of conditions. For example, a clinical clue may provide a short video clip showing how to perform a calcaneal squeeze, example photographs of specific rashes, or an audio sample of a particular breathing pattern.

Clinical clues may allow practitioners to develop skills more rapidly and allow for decreased on-the-job training. Moreover, systematic guidance may serve as reminders to practitioners preventing them from overlooking possibilities or misdiagnosing symptoms. In various embodiments, clinical clues may be associated with examination steps, impressions, or treatment plans. Clinical clues may be triggered as alerts if certain conditions are met. An examination step may comprise of a question such as “Does it look like this?”, whereupon a clinical clue illustrating a particular rash is displayed. According to various embodiments, a clinical clue may provide links or automatic navigation to external databases or Internet resources related to an examination step, impression, treatment plan, and/or other element within the system.

At 240, the results of the examination may be recorded. By utilizing a template, examinations may be standardized, thus allowing a variety of medical practitioners to employ a consistent approach, rather than an ad hoc examination that differs based on each practitioner's experience and training. Such consistency may allow medical practitioners to develop and refine examination templates to reduce the risk of errors and/or omissions in conducting patient examinations.

According to various embodiments, the input provided by the practitioner may result in addition examination steps, at 245. As discussed above, a response to an examination step may result in addition inquiry. Accordingly, examination steps within an examination template may be organized in a tree structure, such that some examination steps are conditional and only displayed if triggered.

An examination summary may be displayed, at 250, to provide a summary view of the findings of the examination. According to various embodiments, the examination may include a number of individual steps or assessments, some of which may not be displayed in the examination summary. Instead, the examination summary may omit irrelevant and/or cumulative information. Accordingly, the examination summary may include pertinent history, pertinent examination results, a medical impression, and/or a treatment plan. In addition, according to some embodiments, a probability or likelihood may be associated with each medical impression generated. In various embodiments, practitioners may customize information that appears on the examination summary in order to display the information that each practitioner deems pertinent or otherwise useful.

According to various embodiments, the results of each patient visit are stored and over time the accumulated information may be used to improve the process. For example, knowledge of prior injuries, sicknesses, and/or complaints may improve the efficiency of examination templates for a particular patient. Additionally impression probabilities may be more accurate. In certain embodiments, historical information may be retained and analyzed so that diagnoses associated with each examination may serve as a data point for estimating the likelihood of a variety of conditions.

According to various embodiments, a practitioner is able to override the impression generation process and manually input impressions based on the practitioner's personal experience. Treatment plans may be generated for manually input impressions. Additionally, manually input impressions may be utilized in future examinations for generating the probabilities of subsequent impressions. In certain embodiments, the impression probabilities may be tied to the results of ongoing medical research published in medical journals and other sources. In this way, a practitioner may have the benefit of such information even if the practitioner has not personally reviewed the results of the research. Similarly, the results and/or details of the patient's examination may be provided to data collection organizations and programs for use in future studies.

Treatment plans associated with the examination summary, at 245, may be based on a wide range of published sources such as medical journals, industry publications, and/or treatment plans utilized by the practitioner in the past.

At 265, an electronic medical record (EMR) may be prepared. The EMR may be stored and utilized in the future when similar circumstances are encountered. Over time, treatment plans may be refined and updated based on past experiences, whether in general or for a specific patient. Further, in instances where the treatment plan involves future activities (e.g., a follow-up visit in three months, altering the dose of a prescribed medication after a specified time, etc.), the patient may be reminded at the appropriate time. The reminder may be handled automatically, thus providing a convenience for the patient while not imposing an additional burden on the practitioner.

Furthermore, the EMR may encapsulate the results entered into the examination template together with the impression selected by the practitioner and the selected treatment plan. All of this information may be associated with the patient and may become a part of the patient's medical history.

Additionally, at 270, a bill for the examination may be prepared. Completing the examination template contemporaneously with the examination may allow certain embodiments to automatically perform evaluation & management (E&M) coding. Automatic E&M coding may save time and expense by ensuring that coders have all of the information required for billing, while costing the practitioner no additional time.

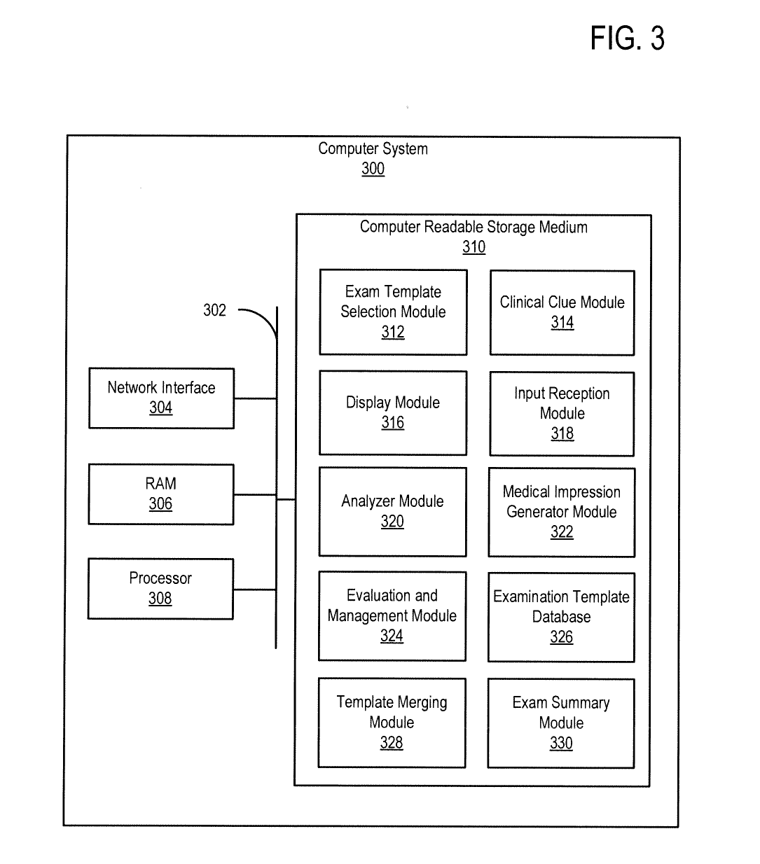

FIG. 3 illustrates a functional block diagram of one embodiment of a system 300 for providing electronic medical support. A computer system 300 may include a processor 308 in communication via bus 302 with memory (RAM 306), a computer-readable storage medium 310, and an optional network interface 304. Processor 308 may be embodied as a general-purpose processor, an application specific processor, a microcontroller, a digital signal processor, or other device known in the art. Processor 308 may be configured to perform logical and arithmetic operations based on program code stored within computer-readable storage medium 310. Computer-readable storage medium 310 may comprise various software modules for providing electronic medical support. The modules described within computer-readable storage medium 310 may be implemented as software, hardware, firmware, or a combination thereof.

Computer-readable storage medium 310 may include an examination template selection module 312, a clinical clue module 314, a display module 316, an input reception module 318, an analyzer module 320, a medical impression generator module 322, an evaluation and management module 324, an examination template database 326, a template merging module 328, and an examination summary module 330. Each module may perform a particular task associated with system 300. One of skill in the art will recognize that certain embodiments may utilize more or fewer modules than are shown in FIG. 3.

Exam template selection module 312 may be configured to receive a selection of at least one examination template from examination template database 326. According to various embodiments, each examination template stored within examination template database 326 includes at least one examination step. The selection of an examination template may be a manual selection or an automatic selection based on one or more chief complaints of a patient.

Examination template database 326 may also be configured to allow the creation and/or editing of examination templates. Display module 316 may be configured to display the examination steps of a selected examination template as well as provide general navigation and search functionality of an electronic medical support system.

One or more of the examination steps on an examination template may be associated with a clinical clue, as is described above. According to various embodiments, clinical clue module 314 may be configured to display a clinical clue associated with an examination step. Given that a clinical clue may be in the form of text, audio, video, and/or combinations thereof, the term “display” as used with respect to a clinical clue includes, without limitation, various forms of audio and/or visual presentations.

According to various embodiments, input reception module 318 is configured to receive input from a practitioner via any one of a wide variety of input devices. Specifically, a practitioner may provide input via a keyboard, mouse, joystick, track pad, rollerball, touchscreen, and/or the like. Additionally, according to various embodiments, an electronic medical support system may include, or be coupled to, voice recognition software to receive speech inputs.

Analyzer module 320 may be configured to analyze the input received from a practitioner. Evaluation and management module 324 may be configured to select at least one additional examination steps in response to the input received from a practitioner. This may continue until an examination is finished.

After the examination is finished, medical impression generator module 322 may determine a medical impression based on the analysis of the received inputs provided by the practitioner. Additionally, medical impression generator module 322 may determine a probability of each impression and/or suitable treatment plan(s).

According to various embodiments, a probability is associated with each medical impression generated, indicating the likelihood that a particular medical impression is accurate. Probabilities may be generated utilizing the inputs provided by the practitioner, various electronic databases of medical information, historical medical records of a particular patient, historical data of a related group of patients, and/or information manually input by a practitioner.

According to various embodiments, medical impression generator module 322 may be configured to analyze received inputs based on a system of rules. That is, an electronic medical support system may be configured to operate using logical rules to determine appropriate examination templates, diagnostic steps, medical impressions, and/or probabilities for a particular patient.

Accordingly, medical impression generator module 322 may be configured to analyze inputs utilizing any of a variety of logical rules and/or algorithms to determine appropriate examination templates, examination steps, diagnostic steps, medical impressions, and/or probabilities. Logical rules, algorithms, and/or processes that may be utilized by medical impression generator module 322 include conditional statements and conditional constructs such as If/Then statements, If/Then/Else statements, and Else/If statements.

Additionally, medical impression generator module 322 may utilize various conditional statements commonly used in programming languages, such as “case” and “switch” statements as well as pattern matching, and/or branch prediction techniques. Medical impression generator module 322 may utilize deduction rules, derivation rules, transformations, reaction rules, event triggering rules, and/or one or more variations of rule-based fuzzy logic.

Alternatively, or additionally, medical impression generator module 322 may utilize dynamic dispatch techniques known to those in the computer arts to establish and execution path from a chief complaint to a examination template, examination step, diagnostic step, medical impression, and/or a probability associated therewith.

An example process utilizing rules based logic is provided herein: A patient's chief complaint may be “ankle pain”, resulting in an “Ankle Injury” template being selected. One of the examination steps may request the amount of time the ankle has been in pain. According to one exemplary embodiment, the medical impression generator module 322 may be configured to automatically select “Osteochondral Ankle Injury” as the medical impression and indicate that an MRI should be performed if the amount of time the ankle has been in pain (or the injury occurred) is longer than 60 days. Alternatively, medical impression generator 322 may select “Osteochondral Angle Injury” as one of a set of possible medical impressions and indicate that an MRI should be performed as a diagnostic step for further confirmation.

Returning to FIG. 3, examination summary module 330 may prepare a summary of the most pertinent examination steps, inputs provided by the practitioner, medical impressions, follow-up information, and/or treatment plans. Additional details and manual inputs may be included at the discretion of a practitioner.

According to various embodiments if multiple examination templates are selected via examination template selection module 312, examination template merging module 328 may be configured to merge the two examination templates. As previously described, the merged examination template may omit redundant and/or cumulative examination steps. For example, if two examination templates include the same examination step, one instance of the examination step will be omitted from the merged examination template.

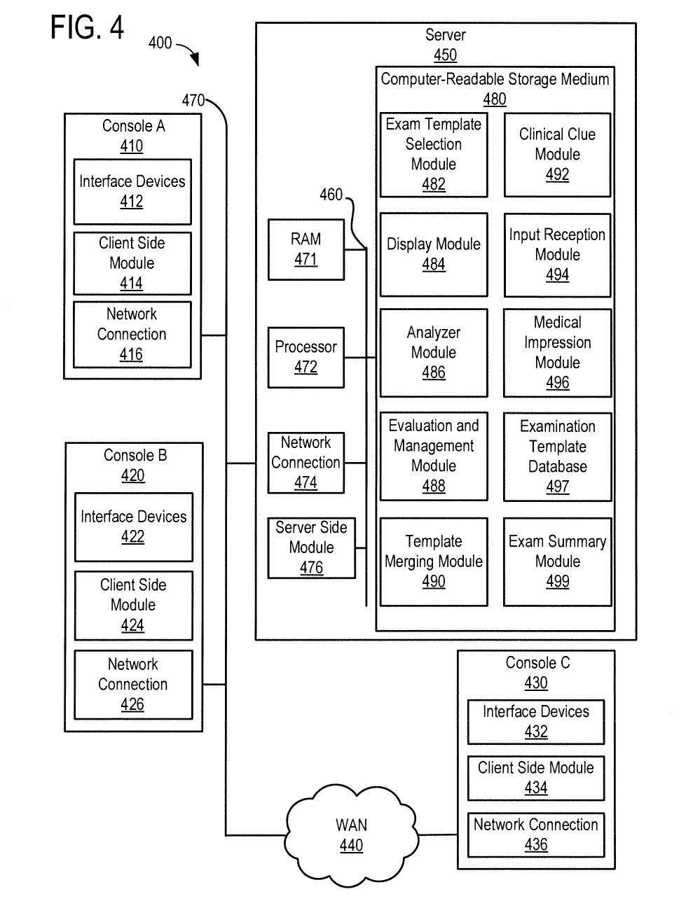

FIG. 4 illustrates a function block diagram of one embodiment of a system 400 for providing electronic medical support. A plurality of consoles 410, 420, 430 are connected by a network 470 to a server 450. As illustrated, console A 410 and console B 420 may be connected by local area network (LAN) 470, while console C 430 may be connected by a wide area network (WAN) 440. Network 470 may carry data traffic between consoles 410, 420, 430, and server 450. In alternative embodiments, a peer-to-peer system may be employed instead of the server-client system shown in FIG. 4. In such embodiments, various modules illustrated in connection with server 450 may be stored and executed on one or more peer computers.

Consoles 410, 420, 430 may be implemented in a variety of ways, such as computers, workstations, terminals, virtual machines, and the like. Consoles 410, 420, 430 may each respectively include interface devices 412, 422, 432, a client side module 414, 424, 434, and a network connection 416, 426, 436. Interface devices 412, 422, 432 may allow a practitioner to interact with server 450 via a respective console. Such interaction may provide a practitioner access to a remote electronic medical support system located on server 450.

Client side modules 414, 424, and 434 may interact with server side module 476 resident on server 450. FIG. 4 illustrates a system with three consoles 410, 420, 430; however, it is contemplated that system 400 may comprise any number of consoles. In one embodiment, client side modules 414, 424, and 434 may be embodied as an Internet browser, and server side module 476 may be embodied as an Internet web server.

Server 450 may include RAM 471, processor 472, a network connection 474, and a computer-readable storage medium 480, in communication via bus 460. Processor 472 may be embodied as a general-purpose processor, an application specific processor, a microcontroller, a digital signal processor, or other device known in the art. Processor 472 may perform logical and arithmetic operations based on program code stored within the computer-readable storage medium 480.

Computer-readable storage medium 480 may include an examination template selection module 482, a clinical clue module 492, a display module 484, an input reception module 494, an analyzer module 486, a medical impression module 496, an evaluation and management module 488, an examination template database 497, a template merging module 490, and an examination summary module 499. Each module may perform a particular task associated with system 400. One of skill in the art will recognize that certain embodiments may utilize more or fewer modules than are shown in FIG. 4.

According to various embodiments, each of modules 482-499 may be configured to perform similarly to any of the various embodiments of the modules described in conjunction with FIG. 3. For example, examination template selection module 482 may be configured to receive a selection of at least one examination template from examination template database 497. Display module 484 may be configured to display the examination steps of a selected examination template. Clinical clue module 492 may be configured to provide a clinical clues associated with examination steps. Input reception module 494 may be configured to receive input from a practitioner utilizing one of consoles 410, 420, 430. Analyzer module 486 may be configured to analyze the input received from a practitioner. Evaluation and management module 488 may be configured to select additional examination steps to be displayed in response to received inputs. Medical impression generator module 496 may determine a medical impression based on the analysis of the received inputs provided by the practitioner. Examination summary module 499 may prepare a summary of the examination for the practitioner. Examination template merging module 490 may be configured to merge multiple examination templates as previously described.

In addition to the illustrated modules useful for performing a patient exam, computer-readable storage medium 480 may further include various modules for managing and creating patient files, groups, and bills. For instance, computer-readable storage medium 480 may include a patient module configured to store information regarding patients, such as medical history, contact information, medical insurance information, and the like. The patient module may allow for patient information to be edited and new patients to be added.

Additionally, a group module may be configured to store information regarding organizations. As discussed above, groups may be based on one or more shared characteristics. A billing module may be configured to create and/or allow editing of bills for patients. The billing module may interact with the patient module and/or group module in order to generate bills that satisfy the requirements of various health insurance providers.

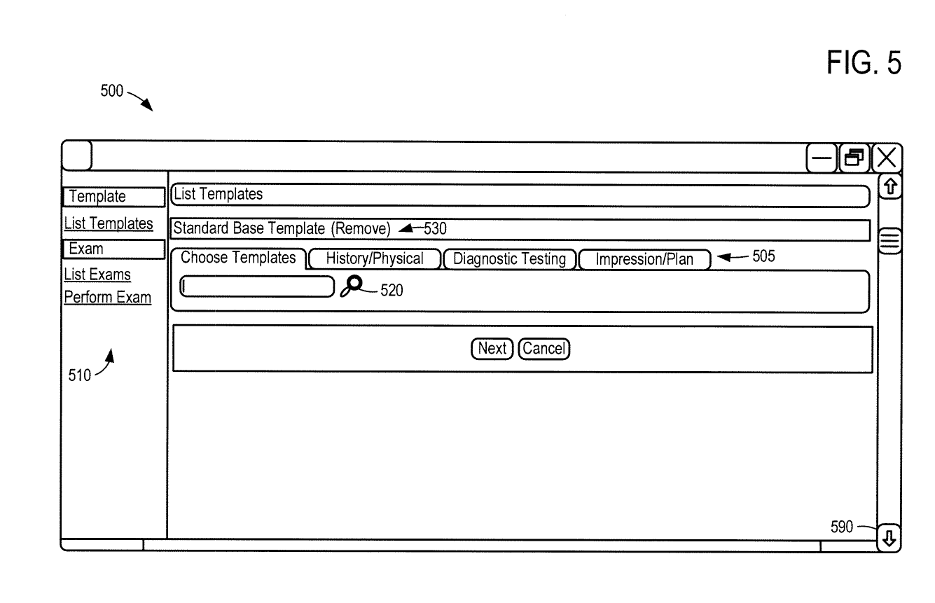

FIGS. 5-12 illustrate exemplary embodiments of screens a practitioner may encounter while performing a patient examination. The illustrated embodiments are by way of example only and do not illustrate all of the various alternative embodiments. Numerous alternative embodiments, interfaces, designs, layouts, and feature sets are contemplated, though not explicitly illustrated in the drawings.

FIG. 5 illustrates an exemplary home screen 500 of an electronic medical support system, including a sidebar 510 for navigation, a search function 520 for searching for an examination template, and tabs 505 for quick navigation within a patient examination. According to various embodiments, by selecting “List Templates” within sidebar 510, a practitioner may be presented with a list of available examination templates. Alternatively, a practitioner may search for a specific examination template by typing in search field 520. According to another embodiment, a practitioner may enter one or more chief complaints and the electronic medical support system may automatically select the appropriate examination template(s). As illustrated, the currently selected examination templates may be listed for reference on the home screen 500. As illustrated, the “Standard Base Template” has been selected, at 530. By selecting the “Remove” link, near 530, the examination template may be removed from the current examination. According to the illustrated embodiments, scroll bar 590 may allow for scrolling within screen 500.

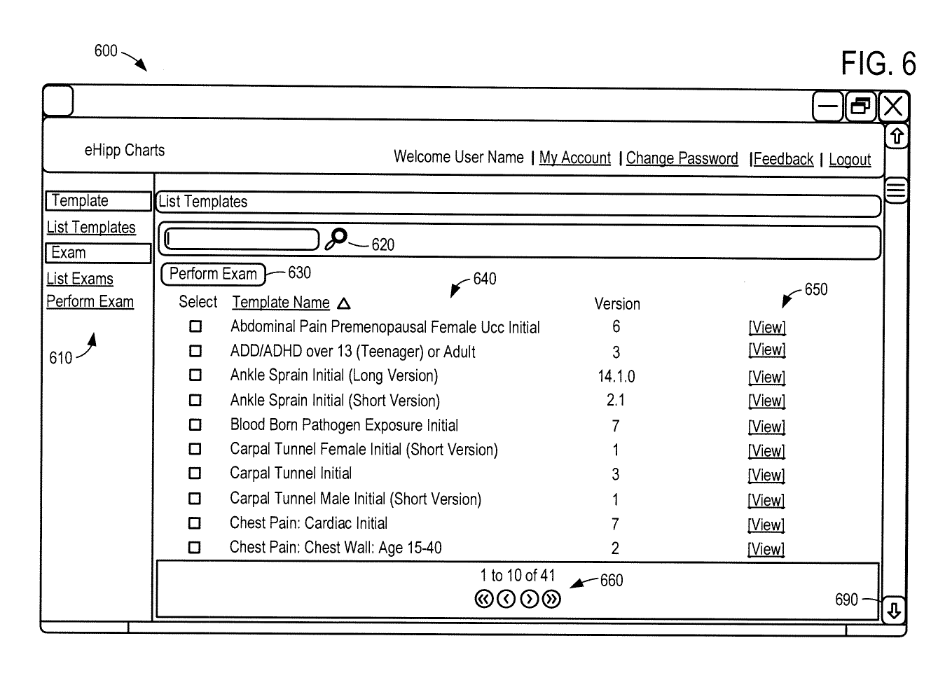

FIG. 6 illustrates a “List Templates” screen 600 presenting a list of available examination templates 640. According to various embodiments, sidebar 610 may continue to be available for navigation within the electronic medical support system. The illustrated screen 600 may be accessed, according to various embodiments, by selecting the “List Templates” link within sidebar 610. A search function 620 may be available to search the listed examination templates 640. Additional details about a specific examination template 640 may be available to a practitioner by selecting “View” at 650. Navigation buttons 660 and/or scroll bar 690 may be available to navigate between the various pages of examination templates 640. Once the desired examination template(s) are selected, a practitioner may select “Perform Exam”, at 630, to begin an examination.

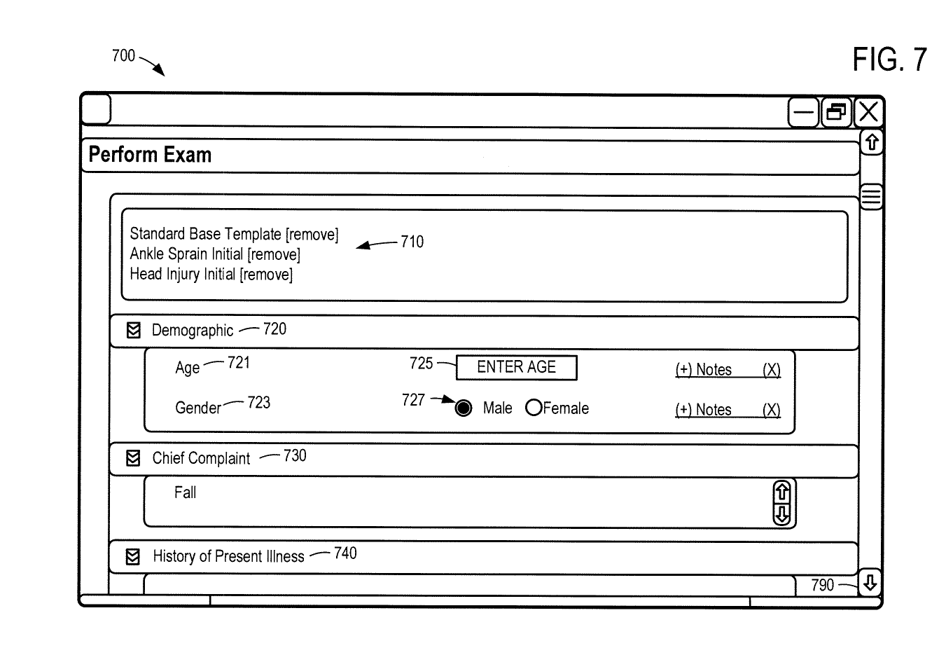

FIG. 7 illustrates an exemplary screen 700 of a merged examination template created from the “Standard Base Template”, an “Ankle Sprain Initial”, and a “Head Injury Initial” examination templates, at 710. As previously described, redundant and/or cumulative examination steps may be omitted to improve efficiency. Examination steps may include various questions, such as the illustrated inquiries related to demographics 720 and the patient's chief complaint 730. Merely by way of example, FIG. 7 includes questions regarding age 721 and gender 723 and allows answers to be input using text field 725 and radio buttons 727. Additional notes may be manually input by a practitioner if desired. Additionally, questions may be related to the history of the present illness 740. According to various embodiments, a practitioner may scroll down, at 790, to view additional examination steps. According to alternative embodiments, an examiner may navigate to various pages using a sidebar, navigation buttons, and/or tabs, similar to those previously described.

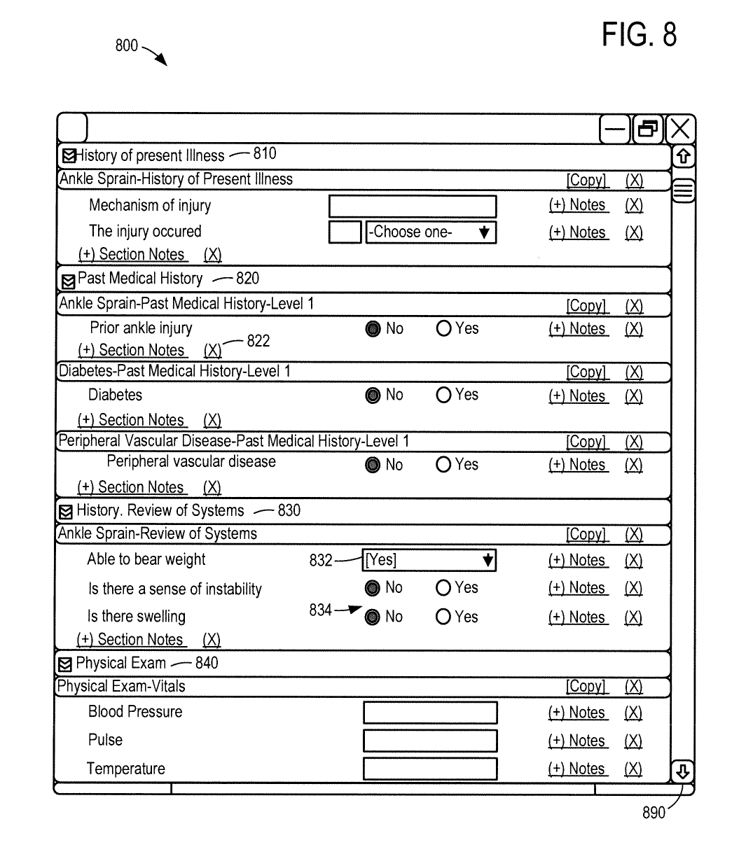

FIG. 8 is another screen 800 illustrating additional examination steps that may be included on a merged examination template. As illustrated, the examination template may include questions relating to a history of the present illness 810, a past medical history 820 (illustrated as Diabetes and Peripheral Vascular Disease), a review of symptoms 830, and a physical examination 840. In the section relating to history of the present illness 810, information about any prior ankle injury, may be recorded. If any of these conditions are applicable, in various embodiments, additional information fields may be displayed, or additional information may be entered into the section notes field 822. Information fields 832 and 834, in the section relating to review of symptoms 830, illustrate that different types of fields may be used in the same template. Information field 834 may comprise radio buttons, while information field 832 may comprise a drop down box. The drop down box of information field 832, may allow a practitioner a variety of options in responding to the question of whether the injured ankle is able to bear weight. For example, options might include, “yes,” “no,” or “partially.” In the section relating to a physical examination 840 a patient's vital information may be recorded. Additional examination questions may be available by scrolling, at 890.

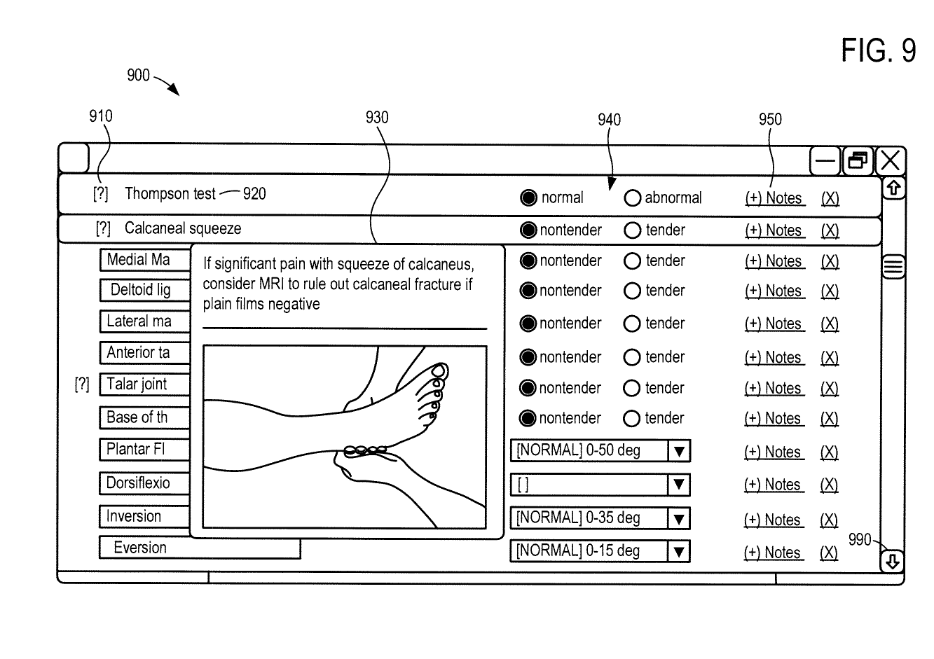

FIG. 9 illustrates a screen 900 showing a clinical clue window 930 pertaining to a particular procedure used in the examination of an injured ankle. The illustrated examination template includes several examination steps. The [?] symbol, at 910, indicates that a clinical clue is available for the particular examination step. A practitioner may select the [?] symbol, at 910, to display clinical clue window 930 configured to provide information about the procedure. Clinical clue window 930 may present information in any of a wide variety of forms, including text, photographs, video, audio, or combinations thereof. Clinical clue window 930 may provide detailed instructions consisting of a plurality of sequential steps or interactive decision-making protocols. Input fields 940 may allow a practitioner to enter the results of the examination steps. As illustrated the input fields comprise radio buttons and drop down boxes; however, according to alternative embodiments any type of input may be utilized, including speech recognition. Notes 950 may allow the practitioner to input additional information relating to a specific examination step. Additionally, by scrolling, at 990, a practitioner may continue on to more examination steps.

As previously described, the examination steps of an examination template may be organized in a tree structure, such that some examination steps are only presented if a triggering examination step is answered in a certain way. For example, if a practitioner indicates that there is no pain in the foot, it may be unnecessary to perform additional examination steps relating to the foot. Similarly, a practitioner's response of “Tender” with regards to the calcaneal squeeze test may cause additional examination steps related to the calcaneal squeeze test to be presented to the practitioner.

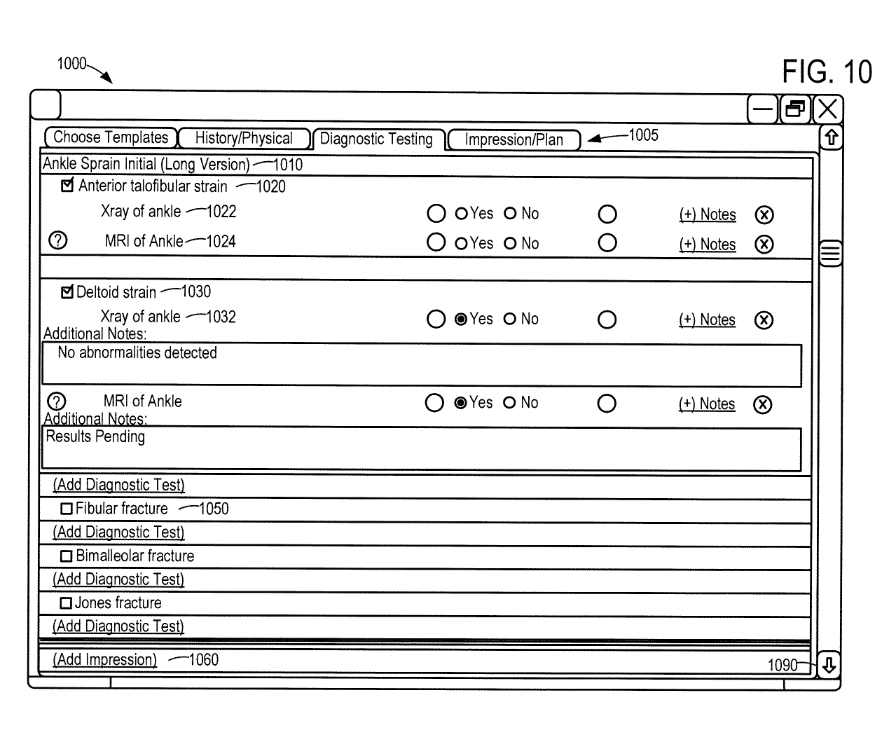

FIG. 10 illustrates an additional screen 1000 illustrating the tab labeled “Diagnostic Testing”, at 1005. Accordingly, a practitioner may select that he or she has detected specific problems related to an angle sprain, at 1010. For example, an anterior talofibular strain, at 1020, may be detected with an X-ray of the ankle, at 1022, or using an MRI, at 1024. As illustrated, only the checked diagnostics allow for radio buttons to be checked and comments to be provided. For example, under Deltoid strain, at 1030, an X-ray, at 1032 was performed and the comments indicate that “no abnormalities [were] detected.” Similarly, an MRI is indicated as having been performed, but the “results [are] pending.” Additional diagnostic tests may be added at the practitioner's discretion, at 1050. System 1000 may recommend a diagnostic test based on prior examination steps performed by the practitioner. Again, scrolling, at 1090, may present additional diagnostic tests or the ability to add impressions, at 1060.

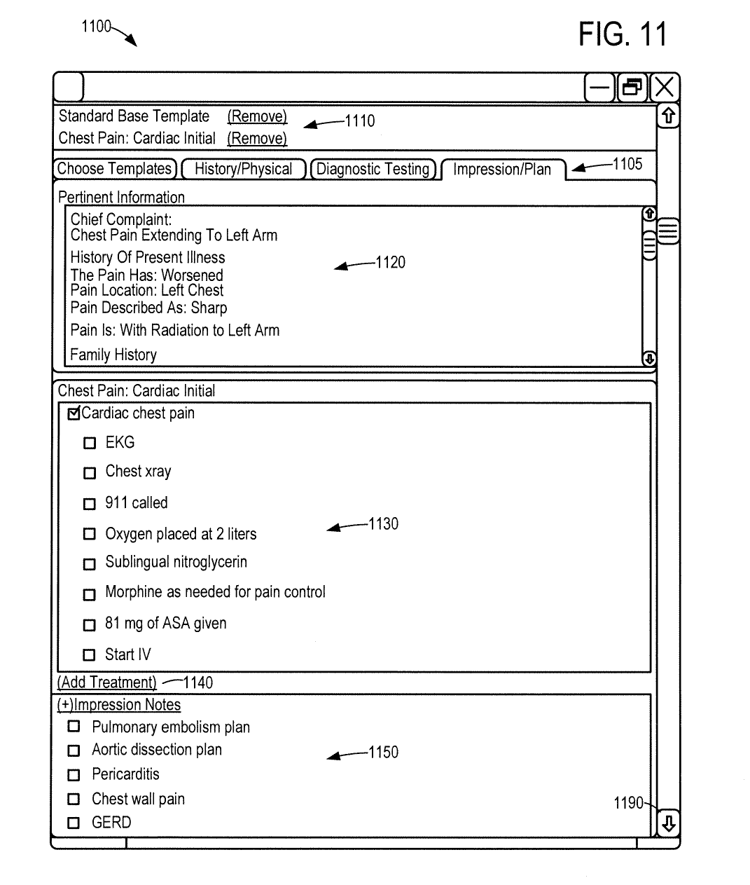

FIG. 11 illustrates a screen 1100 showing an impression/plan tab, at 1105. According to various embodiments, following examination steps and/or diagnostic testing, a practitioner may be presented with medical impressions and/or treatment plans. As illustrated, an examination summary may be provided to the practitioner highlighting the pertinent information, at 1120, obtained from the two examination templates, at 1110. According to various embodiments, each item within the pertinent information field 1120 may be a link to additional information, or a scroll bar may be available for a more detailed analysis of the most pertinent information.

Additionally, a medical impression relating to a specific problem may be provided, at 1130. In the illustrated example, a patient's chief complaint of “chest pain” is determined to be cardiac chest pain. Accordingly, treatments may include an EKG, a chest x-ray, 81 mg of ASA, and the like. As each treatment is provided, it may be checked off in order to prevent accidental re-treatment. Additional treatments may be added, at 1140, and a practitioner may manually add additional impressions, at 1150. Again, scroll bar 1190 may allow a practitioner to access additional information or options.

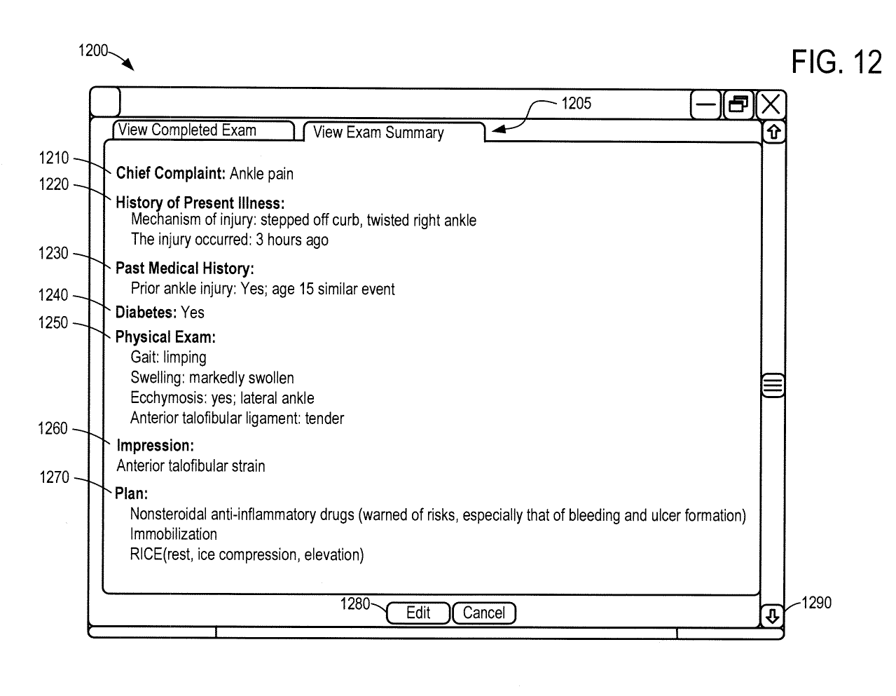

FIG. 12 illustrates another embodiment of an examination summary. A screen 1200 showing an exemplary examination summary including two tabs, the “Exam Summary” and the “View Completed Exam,” at 1205. Examination summary 1205 may be based on the results of the examination and may present, in a summary manner, the results of the examination. In the illustrated example, examination summary 1205 includes the chief complaint 1210, the history of the present illness or injury 1220, past medical history 1230, the fact that the patient had diabetes 1240, the results of a physical examination 1250, an impression 1260, and a treatment plan 1270. The examination summary 1200 may be edited as desired by a practitioner, at 1280. Again, scroll bar 1290 may provide navigation of examination summary 1200.

The above description provides numerous specific details for a thorough understanding of the embodiments described herein. However, those of skill in the art will recognize that one or more of the specific details may be omitted, modified, and/or replaced by a similar process or system.

What is claimed:

1. An electronic examination template comprising:
an examination step relating to a medical complaint;
a clinical clue associated with the examination step configured to inform a user on how to proceed with the examination step;
an information field configured to allow a user to input information relating to the examination step.

2. The electronic examination template of claim 1, wherein the clinical clue comprises one of an image, an audio clip, and a video clip.

3. The electronic examination template of claim 1, wherein the examination step comprises a predefined question.

4. The electronic examination template of claim 3, wherein the predefined question relates to a physical exam.

5. The electronic examination template of claim 1, wherein the information field comprises one of a drop down box, radio button, and a text field.

6. The electronic examination template of claim 1, wherein the examination template further comprises a notes section configured to receive notes pertaining to the examination step.

7. A method for creating a merged examination template comprising:
receiving a selection of a first examination template from among a plurality of examination templates, wherein each examination template comprises a plurality of examination steps;
receiving a selection of a second examination template from among the plurality of examination templates;
identifying at least one examination step included in both the first examination template and the second examination template;
merging the first examination template and the second examination template to create a first merged examination template;
omitting duplicate instances of the identified at least one examination step included in both the first examination template and the second examination template, such that only one instance of each identified examination step included in both the first examination template and the second examination template is included in the first merged examination template.

8. The method of claim 7, wherein the selection of an examination template comprises receiving a patient complaint.

9. The method of claim 7, further comprising:
receiving a selection of a third examination template from among the plurality of examination templates;
identifying at least one examination step included in both the first merged examination template and the third examination template;
merging the first merged examination template and the third examination template to create a second merged examination template;
omitting duplicate instances of the identified at least one examination step included in both the first merged examination template and the third examination template, such that only one instance of each identified examination step included in both the first merged examination template and the third examination template is included in the second merged examination template.

10. A method for generating a medical impression, comprising:
receiving a selection of a first examination template from among a plurality of examination templates, each examination template comprising a plurality of examination steps;
displaying at least a portion of the examination steps of the first examination template via a display;
receiving input via an interface device relating to at least one of the displayed examination steps of the first examination template;
analyzing the received input; and
generating at least one medical impression based at least partially on the analysis of the received input.

11. The method of claim 10, further comprising:
displaying at least one additional examination step of the set of examination steps of the first examination template in response to the received input;
receiving input via an interface device relating to the at least one addition examination step;
analyzing the received input relating to the at least one addition examination step; and
wherein generating the at least one medical impression is further based on the analysis of the at least one addition examination step.

12. The method of claim 10, wherein the selection of a first examination template from among a plurality of examination templates comprises receiving a patient complaint.

13. The method of claim 10, wherein an examination step comprises a predefined question.

14. The method of claim 13, wherein the predefined question relates to a physical exam.

15. The method of claim 10, further comprising generating a probability for each of the generated medical impressions.

16. The method of claim 10, further comprising:
receiving a selection of a second examination template from among the plurality of examination templates;
identifying at least one examination step included in both the first examination template and the second examination template;
merging the first examination template and the second examination template to create a merged examination template, wherein the merged examination template omits duplicate instances of the identified at least one examination step included in both the first examination template and the second examination template, such that only one instance of each identified examination step included in both the first examination template and the second examination template is included in the merged examination template.

17. The method of claim 16, wherein the selection of a first examination template comprises receiving a first patient complaint; and wherein the selection of the second examination template comprises receiving a second patient complaint.

18. The method of claim 10, further comprising:
displaying an examination summary comprising:
at least one input received via the interface device that is relevant to medical decision making;
at least one medical impression; and
at least one possible treatment plan for the at least one medical impression.

19. The method of claim 10, further comprising displaying a clinical clue associated with a displayed examination step of the first examination template, the clinical clue comprising contextually relevant material.

20. The method of claim 19, wherein the clinical clue comprises one of an image, an audio clip, and a video clip.

21. The method of claim 19, wherein the clinical clue comprises sufficient information to educate a user on how to proceed with the associated examination step of the first examination template.

22. The method of claim 10, wherein analyzing the received input comprises utilizing a set of logic rules.

23. The method of claim 22, wherein the set of logic rules comprises If/Then statements.

24. An electronic medical support system, comprising:
a processor; and
a computer-readable storage medium in communication with the processor, the computer-readable storage medium comprising:
an examination template selection module executable on the processor configured to receive a selection of a first examination template from among a plurality of examination templates, each examination template comprising a plurality of examination steps;
a display module executable on the processor configured to display at least a portion of the examination steps of the first examination template;
an input reception module executable on the processor configure to receive an input from an interface device relating to examination steps displayed by the display module;
an analyzer module executable on the processor configured to analyze input received from the interface device;
a medical impression generator module executable on the processor configured to generate at least one medical impression based at least partially on the analysis of the input received from the interface device.

25. The system of claim 24, wherein the computer-readable storage medium further comprises an evaluation and management module executable on the processor configured to select at least one additional examination step of the first examination template to be displayed by the display module in response to the input received from the interface device.

26. The system of claim 24, wherein the computer-readable storage medium further comprises a plurality of examination templates, each examination template comprising a plurality of examination steps.

27. The system of claim 24, wherein the selection of a first examination template from among a plurality of examination templates comprises receiving a patient complaint.

28. The system of claim 24, wherein an examination step comprises a predefined question.

29. The system of claim 28, wherein the predefined question relates to a physical exam.

30. The method of claim 24, wherein the medical impression generator module is further configured to generate a probability for each of the generated medical impressions.

31. The method of claim 24, wherein the computer-readable storage medium further comprises a template merging module configured to:
compare the examination steps of a first examination template and the examination steps of a second examination template;
identify examination steps included in both the first examination template and the second examination template;
merge the first examination template and the second examination template to create a merged examination template, wherein the merged examination template omits duplicate instances of identified examination steps included in both the first examination template and the second examination template, such that only one instance of each identified examination step included in both the first examination template and the second examination template is included in the merged examination template.

32. The system of claim 24, wherein the computer-readable storage medium further comprises an examination summary module configured to create an examination summary including:
at least one input received from the interface device that is relevant to medical decision making;
at least one medical impression; and
at least one possible treatment plan for the at least one medical impression.

33. The system of claim 24, wherein the computer-readable storage medium further comprises a clinical clue module configured to display a clinical clue associated with an examination step displayed by the display module.

34. The system of claim 33, wherein the clinical clue comprises one of an image, an audio clip, and a video clip.

35. The system of claim 33, wherein the clinical clue comprises sufficient information to educate a user on how to proceed with the associated examination step displayed by the display module.

36. The system of claim 24, wherein the analyzer module is configured to analyze input received from the interface device using a set of logical rules.

37. The system of claim 36, wherein the set of logic rules comprises If/Then statements.

38. A electronic medical support network system, comprising:
a plurality of consoles, each console comprising:
a client side module configured to communicate with a server via a network connection; and
an interface module configured to receive information and display information;
a server in communication with the plurality of consoles, the server comprising:
a processor;
a server side module configured to communicate with each of the plurality of consoles via a network connection;
a computer-readable storage medium comprising:
a plurality of examination templates, each examination template comprising a plurality of examination steps;
an examination template selection module executable on the processor configured to receive a selection of a first examination template from among the plurality of examination templates;
a display module executable on the processor configured to display at least a portion of the examination steps of the first examination template;
an input reception module executable on the processor configure to receive an input from an interface device relating to examination steps displayed by the display module;
an analyzer module executable on the processor configured to analyze input received from the interface device;
a medical impression generator module executable on the processor configured to generate at least one medical impression based at least partially on the analysis of the input received from the interface device.

39. The network system of claim 38, wherein the computer readable storage medium further comprises a template merging module configured to:
compare the examination steps of a first examination template and the examination steps of a second examination template;
identify examination steps included in both the first examination template and the second examination template;
merge the first examination template and the second examination template to create a merged examination template, wherein the merged examination template omits duplicate instances of identified examination steps included in both the first examination template and the second examination template, such that only one instance of each identified examination step included in both the first examination template and the second examination template is included in the merged examination template.

40. The network system of claim 38, wherein the computer-readable storage medium further comprises an examination summary module configured to create an examination summary including:
at least one input received from the interface device that is relevant to medical decision making;
at least one medical impression; and
at least one possible treatment plan for the at least one medical impression.

41. The network system of claim 38, wherein the computer-readable storage medium further comprises a clinical clue module configured to display a clinical clue associated with an examination step displayed by the display module.

42. The network system of claim 41, wherein the clinical clue comprises one of an image, an audio clip, and a video clip.

43. The network system of claim 41, wherein the clinical clue comprises sufficient information to educate a user on how to proceed with the associated examination step displayed by the display module.

44. The network system of claim 38, wherein the analyzer module is configured to analyze input received from the interface device using a set of logic rules.

45. The system of claim 44, wherein the set of logic rules comprises If/Then statements.
